(19) United States
(12) Patent Application Publication
(10) Pub. No.: US 2009/0260605 A1
(43) Pub. Date: Oct. 22, 2009

(54) STAGED ARRANGEMENT OF EGR COOLERS TO OPTIMIZE PERFORMANCE

(75) Inventors: John Janssen, Nashville, IN (US); Timothy Frazier, Columbus, IN (US); Darald Chao, Darlington (GB)

Correspondence Address: Studebaker & Brackett PC, 1890 Preston White Drive, Suite 105, Reston, VA, 20191, US

(73) Assignee: CUMMINS INTELLECTUAL PROPERTIES, INC., Minneapolis, MN (US)

(21) Appl. No.: 12/260,632

(22) Filed: Oct. 29, 2008

Related U.S. Application Data
(63) Continuation-in-part of application No. 11/933,603, filed on Nov. 1, 2007, now abandoned.

(51) Int. Cl. F02M 25/07

(52) U.S. Cl. 123/568.12

(57) ABSTRACT

A compression ignition engine comprising at least one combustion chamber, an air intake system, a fuel system, an exhaust system and an exhaust gas recirculation system. The air intake system conveys air to the chamber. The exhaust system conveys exhaust gases from the combustion chamber. The exhaust gas recirculation system is capable of recirculating a portion of the exhaust gases into air intake system. The exhaust gas recirculation system comprises a cooler package and a valve. The valve controls the amount of air flow through the cooler package. The cooler package includes a first portion, a second portion and a control valve. The control valve of the cooler package is configured to control whether the air that flows through the cooler package flows only through one of the first or the second portion or through both of the first portion and the second portion in parallel.

### RELATED APPLICATIONS

This application is a continuation-in-part of patent application Ser. No. 11/933,603, filed Nov. 1, 2007, the subject matter of which are hereby expressly incorporated by reference.

### FIELD OF THE INVENTION

The present disclosure generally relates to diesel engines and more particularly to the arrangement of coolers utilized in exhaust gas recirculation in diesel engines.

### BACKGROUND

Diesel engines include cylinders that combust a mixture of compressed air and diesel fuel. Frequently, exhaust gas recirculation (EGR) is utilized to minimize unfavorable emissions, such as NOx emissions, for the combustion of the diesel fuel. The usage of exhaust gas recirculation often impacts fuel economy, especially in turbocharged diesel engines. Moreover, in large duty trucks, the extra heat energy transferred to the coolant requires that the size of the radiators and cooling fans generally be increased in order to maintain engine temperature.

Traditionally, EGR systems have been described as a “high pressure loop” wherein the exhaust is extracted on the high-pressure side of a turbocharger turbine. The exhaust is then returned to the high pressure side of the turbocharger compressor. Accordingly, in order for the exhaust gas to flow in the proper direction, the exhaust manifold pressure must be higher than the intake manifold pressure. In order to achieve this, crankshaft power may be used to deliver power during the pumping loop portion of the engine cycle. Since the EGR in a high pressure loop requires a reversal of the manifold pressure differential as compared to normal engines, the pumping loop portion of the cycle consumes power, rather than delivers power. Thus, the amount of power consumed in the pumping loop portion depends upon the manifold pressure differential. In addition, the flow restriction of the EGR path may also affect the manifold pressure differential.

Much of the flow restriction of an EGR system occurs in the EGR cooler. The size of the cooler generally depends upon several factors. For example, the system may require a cooler large enough (i.e. with sufficient surface area for heat transfer) to deliver low temperature EGR at high power/high flow conditions in order to prevent NOx limits from being exceeded. Unfortunately, large coolers often result in a larger pressure drop, and further require more space for mounting. Moreover, at low power/low flow, the gas flowing through the cooler may deposit soot on the cooler surfaces. As these deposits build up on the surface of the cooler, the deposits insulate the surfaces and impede heat transfer. During laminar flow, the deposits may accumulate to the point where the flow passages become completely blocked, but with turbulent flow, the deposits stabilize at a certain thickness and typically do not block the passages of the cooler.

Furthermore, the first portion of the cooler generally provides a greater reduction in air temperature than the second portion downstream from the first portion. At relatively higher power, the reduction of temperature in the second portion may be necessary to cool the gas, but at lower power with the initial temperature of the gas being lower, the second portion may not effectively cool the gas but still reduce the pressure of the gas as it passes through the cooler.

Additionally, as mentioned above EGR cooler designs attempt to accommodate the lower emission requirements by increasing cooling of the EGR gas, which requires a larger cooler. The increase in cooler package size has reduced the available space for other components on the “hot side’ of the engine. Accordingly, it is desirable to increase the effectiveness of the EGR cooler, while maintaining a compact package configuration.

### SUMMARY

An embodiment of the present disclosure relates to a compression ignition engine comprising at least one combustion chamber, an air intake system, a fuel system, an exhaust system and an exhaust gas recirculation system. In one variation, the air intake system conveys air to at least one combustion chamber. In addition, the fuel system conveys fuel into at least on combustion chamber. Furthermore, the exhaust system conveys exhaust gases from at least one combustion chamber. The exhaust gas recirculation system is capable of recirculating a portion of the exhaust gases into the air intake system. The exhaust gas recirculation system comprises a first exhaust gas recirculation cooler, a second exhaust gas recirculation cooler and a valve positioned intermediate the first cooler and the second cooler. The valve, when opened, allows the exhaust gas to flow in parallel through both the first cooler and the second cooler. When closed, the valve prevents exhaust gas from flowing through the second cooler.

In one variation of the disclosure, the first cooler and the second cooler are liquid cooled. The first cooler is arranged in a parallel relationship with the second cooler. In another variation, a controller is capable of controlling whether the valve is opened or closed. In an extension of this variation, the controller includes a sensor configured to determine the speed of the engine.

In another variation of the disclosure, the engine further includes a third exhaust gas recirculation cooler connected to the first and second exhaust gas recirculation coolers. The third exhaust gas recirculation cooler is further connected to the intake, and the third exhaust gas recirculation cooler is connected in series with the first and second exhaust gas recirculation coolers. In yet another variation, the third exhaust gas recirculation cooler is air cooled. It should be understood, however, that any of the exhaust gas recirculation coolers may be liquid cooled, air cooled, or cooled using any other suitable technique.

As such, a staged arrangement EGR cooler according to the teachings of the present disclosure may incorporate a pair of independent cooler sections and a valve to control the amount of cross-sectional cooler area (by directing EGR gas to one or both cooler sections) as a function of engine load. Additionally, the EGR cooler package may be formed in a compact shape (such as a U-shape) to reduce the space required for mounting the cooler package and permit alternate mounting orientations (e.g. vertical instead of horizontal).

The features and advantages of the present disclosure described above, as well as additional features and advantages, will be readily apparent to those skilled in the art upon reference to the following description and the accompanying drawing.

### BRIEF DESCRIPTION OF THE DRAWINGS

The above-mentioned and other features of this disclosure and the manner of obtaining them will become more apparent and the disclosure itself will be better understood by reference to the following description of embodiments of the disclosure taken in conjunction with the accompanying drawing, wherein:

FIG. 1 depicts a general schematic diagram of portions of an exemplary diesel engine embodying principles of the present disclosure;

FIG. 2 depicts an embodiment of a cooling package in accordance with the principles of the present disclosure; and

FIG. 3 depicts another embodiment of a cooling package in accordance with the principles of the present disclosure.

Although the drawings represents embodiments of various features and components according to the present disclosure, the drawings are not necessarily to scale and certain features may be exaggerated in order to better illustrate and explain the concepts presented herein. The exemplifications set out herein illustrate embodiments of the disclosure, and such exemplifications are not to be construed as limiting the scope of the disclosure in any manner.

### DETAILED DESCRIPTION

For the purposes of promoting an understanding of the principles of the invention, reference will now be made to the embodiments illustrated in the drawings, which are described below. It will nevertheless be understood that no limitation of the scope of the disclosure is thereby intended. The disclosure includes any alterations and further modifications in the illustrated devices and described methods and further applications of the principles of the disclosure, which would normally occur to one skilled in the art to which the disclosure relates. Moreover, the embodiments were selected for description to enable one of ordinary skill in the art to practice the invention.

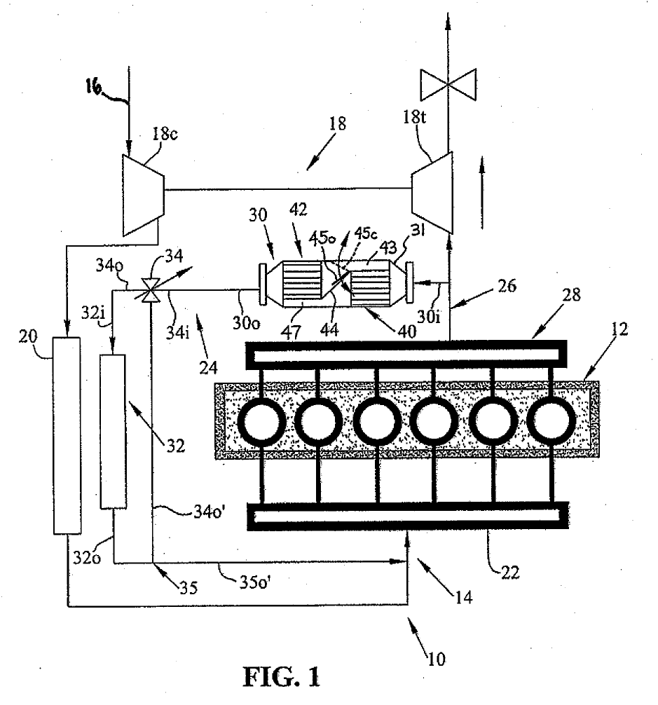

FIG. 1 depicts a portion of an exemplary diesel engine 10 for powering a motor vehicle operating in accordance with an embodiment of the present disclosure. In the depicted embodiment, engine 10 comprises a plurality of cylinders 12 within which pistons (not shown) reciprocate in a known manner. Each piston may be coupled to a respective throw of a crankshaft (not shown) by a corresponding connecting rod (not shown) in an known manner.

Engine 10 further includes an intake system, indicated by numeral 14. Intake system 14 delivers the intake air into each of the cylinders in a known manner. In the depicted embodiments, intake system 14 comprises a fresh air inlet 16. Fresh air inlet 16 conveys ambient air to a compressor 18C of a turbocharger 18. After compressor 18C has compressed the fresh air, a charge air cooler, also known as an intercooler, 20 cools the fresh air before the air passes to an intake manifold 22. In a known manner, air enters a respective cylinder 12 when a respective intake valve or valves of the cylinder 12 is open.

In the depicted embodiment, engine 10 includes an exhaust gas recirculation (EGR) system, indicated by numeral 24, and an exhaust system, generally indicated by numeral 26. EGR 24 provides controlled recirculation of engine exhaust gases from exhaust system 26 of engine 10 to intake system 14 for purposes of emission control.

Exhaust system 26 comprises an exhaust manifold 28 and a turbine 18T of turbocharger 18. Exhaust manifold 28 may be any suitable manifold known in the art. Exhaust system 26 may also include one or more exhaust treatment devices (not shown) such as a diesel particulate filter (DPF) for trapping soot present within the exhaust air in order to prevent the trapped soot from escaping to the surrounding atmosphere, for example.

In the depicted embodiment, EGR system 24 comprises an EGR cooler package, generally indicated by numeral 30, an EGR intercooler 32 and an EGR valve 34. EGR cooler package 30 includes a housing 31, a first portion 40, a second portion 42, a divider wall 44, and a control valve 45. Housing 31 includes an inlet 30i and an outlet 30o. As shown, inlet 30i is in flow communication with first portion 40. Inlet 30i is also in flow communication with a flow path 43 to second portion 42. Flow path 43 is bounded by first portion 40, housing 31 and divider wall 44. The outlet side of first portion 40 is in flow communication with flow path 47, which is bounded by divider wall 44, second portion 42 and housing 31. Flow path 47 and the outlet side of second cooler 42 are in flow communication with outlet 30o of EGR cooler package 30. As indicated above, EGR cooler package 30 may be cooled in any suitable manner, such as jacket water cooling, for example. First portion 40 and second portion 42 of EGR cooler package 30 are each generally configured to cool the air passing through cooler package 30.

In the depicted embodiment, control valve 45 controls the manner in which air flows through cooler package 30. For example, when control valve 45 is in a closed position as depicted in dotted lines and indicated by numeral 45c, all of the air entering package 30 flows through first portion 40 prior to exiting the cooler package 30. None of the air (or at least substantially none of the air) flows through second package 42. Conversely, when control valve 45 is in an opened position as depicted in solid lines and indicated by numeral 45o, a portion of the air flowing through package 30 travels through first portion 40 and the remainder of the air travels through second portion 42 in parallel prior to exiting the cooler package 30. It should be understood that control valve 45 may be configured for controllable positioning in a plurality of positions intermediate the closed position 45c and the opened position 45c referenced above.

EGR charge air cooler, or EGR intercooler, 32, may also be utilized to further cool the air. EGR intercooler 32 may be any type of suitable intercooler, such as an air-cooled, or direct, intercooler, for example. It should be noted that in an alternate embodiment, EGR intercooler 32 may be omitted from engine 10.

Intercooler 32 includes an inlet 32i and an outlet 32o, and valve 34 includes an inlet 34i and outlets 34o and 34o′. In the depicted embodiment, inlet 30i conveys air from exhaust manifold 28 to cooler package 30. Air exiting cooler package 30 travels through outlet 30o and is then conveyed to valve 34 by way of inlet 34i. Air exiting valve 34 may travel from outlet 34o to inlet 32i and then enters intercooler 32. In addition, air exiting valve 34 may travel from outlet 34o′ to join with the air traveling though outlet 32o at junction 35. Outlet 32o conveys air from intercooler 32 to junction 35, and air travels through outlet 35o from junction 35 to intake 14.

It should be noted that in the depicted embodiment, valve 34 controls the flow of air through the EGR system 24. Specifically, valve 34 may direct air into outlet 34o and consequently into intercooler 32, or valve 34 may direct air into outlet 34o′ in order to allow the air to bypass intercooler 32. Furthermore, valve 34 may be fully closed thereby preventing air from flowing through inlet 30i and consequently, preventing air from traveling through cooler package 30. Accordingly, air from exhaust manifold 28 will be communicated to inlet 30i whenever valve 34 is at least partially open. Thus, whenever valve 34 is at least partially open, the air flows through EGR system 24 and into intake 14.

It should be noted that in embodiments of the invention, valve 34 may be replaced with a plurality of valves capable of collectively performing the same function. For example, valve 34 may be replaced with a first valve capable of selectively preventing the flow of air through cooler package 30, and a second valve capable of directing air from input 34i into either output 34o or output 34o′. Moreover, these valves may be placed in any number of suitable positions within the EGR system 24.

In operation, whenever valve 34 is opened and directs air into at least one of output 34o or output 34o′ thereby allowing air to flow through the EGR system 24, cooler package 30 may be in at least one of two different configurations. For example, at low power and low flow, wherein less cooling is necessary, valve 45 may be closed so that air only flows through first portion 40. First portion 40 is configured to ensure the air remains in turbulent flow in order to reduce the amount of soot deposited on first portion 40. When the engine is at a high flow and high power condition, valve 44 may be opened in order to allow the air flowing through the cooler package 30 to flow in parallel through both first portion 40 and second portion 42, i.e. such that a portion of the air flowing through package 30 travels through the first portion 40 and a portion of the air travels through second portion 42. In high power/high pressure conditions, the air flowing through cooler package 30 remains in a turbulent flow state in order to minimize the soot deposited on the portions 40, 42 of the cooler package 30.

In either instance, once the air exits from cooler package 30 by way of outlet 30o, the air passes into valve 34 by way of inlet 34i. Valve 34 may be configured to direct the air into outlet 34o and into intercooler 32 by way of inlet 32i. The passage of the air through intercooler 32 allows the temperature of the air to be lowered prior to the air being conveyed to intake 14 via outlet 32o.

It should be noted that in certain instances, valve 34 may be switched so that the air bypasses intercooler 32. For example, when intercooler 32 is air cooled and the ambient air is below freezing, valve 34 may be switched so that the air bypasses intercooler 32 in order to prevent the condensation of the moisture within the air.

In alternative embodiments, intercooler 32 may be removed from the engine 10, thereby allowing air to pass from cooler package 30 through valve 34 and into intake 14. In embodiments in which intercooler 32 is not present, valve 34 may be located at any suitable position within the EGR system 24.

It should be noted that the valves 34, 45 may be controlled in any suitable manner. For example, an engine control unit (not shown) may be used to control the degree to which the valves 34, 45 are opened. The engine control unit may also include a sensor configured to sense the power output and flow of the engine, in order to ensure the valves 34, 45 are opened appropriately and proper turbulent air flow is maintained through the cooler package 30 in order to minimize the deposit of soot.

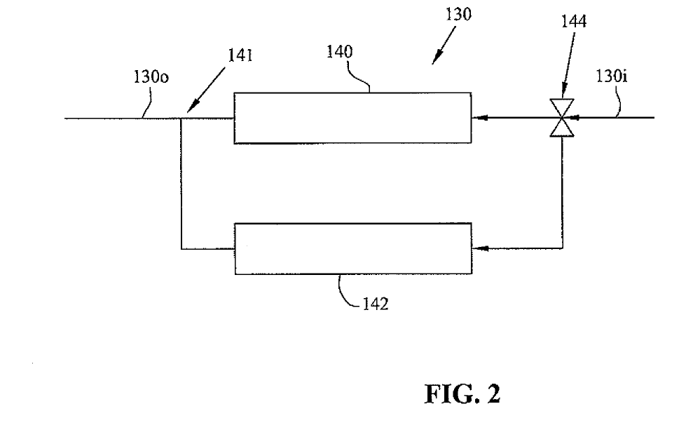

FIG. 2 depicts another embodiment of a cooling package according to the teachings of the present disclosure, generally indicated by numeral 130. In the depicted embodiment, cooling package 130 includes a first cooler 140, a second cooler 142 and a valve 144. Gas enters valve 144 of cooling package 130 by way of inlet 130i, and at least a portion of the gas passes through valve 144 and into first cooler 140. The first cooler 140 cools the gas in a conventional manner.

Valve 144 may also be configured to direct a portion of the gas passing through the valve 144 into second cooler 142. Generally, when valve 144 directs a portion of the gas to second cooler 142, valve 144 continues to direct a portion of the gas to the first cooler 140. In the depicted embodiment of cooling package 130, the gas flowing through first cooler 140 and second cooler 142 recombines at junction 141 in a suitable manner. The recombined gas may then exit cooling package 130 via outlet 130o. It should be noted that in embodiments of the invention, first cooler 140 and second cooler 142 may be liquid cooled.

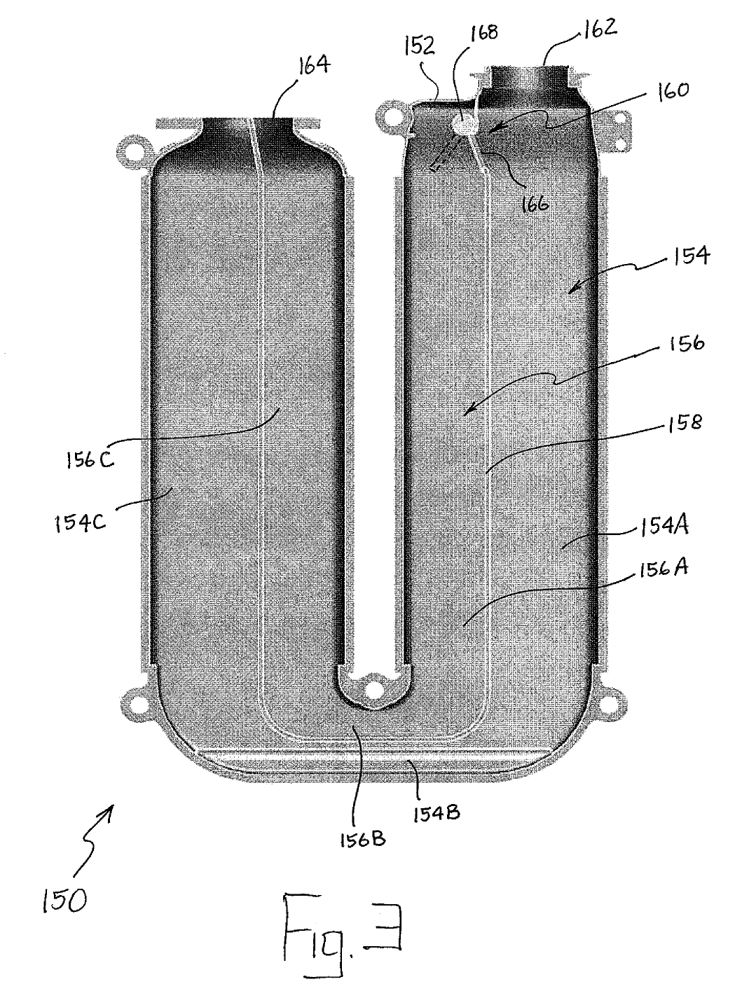

Referring now to FIG. 3, another embodiment of an EGR cooler is shown. Cooler package 150 includes a housing 152, a first cooler core (first portion 154), a second cooler core (second portion 156), a divider wall 158, and a control valve 160. As shown, first portion 154 and second portion 156 are enclosed within housing 152, which is formed in a U-shape. Accordingly, first portion 154 includes a substantially straight inlet segment 154A, a curved segment 154B, and a substantially straight outlet segment 154C. Similarly, second portion 156 includes a substantially straight inlet segment 156A (disposed substantially parallel to inlet segment 154A), a curved segment 156B (disposed substantially parallel to inlet segment 154B), and a substantially straight outlet segment 156C (disposed substantially parallel to inlet segment 154C). Housing 152 includes an inlet 162 and an outlet 164. As shown, inlet 162 is in flow communication with inlet segment 154A of first portion 154. First portion 154 is entirely separated from second portion 156 from inlet 162 to outlet 164 by the combination of divider wall 158 and control valve 160. Both outlet segment 154C of first portion 154 and outlet segment 156C of second portion 156 are in flow communication with outlet 164.

Control valve 160 is depicted in this embodiment as a flapper valve, with a movable portion 166 coupled to a pivotal connection 168 that is mounted to housing 152. Movable portion 166 is configured to obstruct, when valve 160 is in the closed position shown in solid lines in FIG. 3, an opening in divider wall 158 between inlet segment 154A and inlet segment 156A. Thus, when valve 160 is in the closed position, gas is substantially prevented from flowing through second portion 156 of package 150. When valve 160 is in the opened position as shown in dotted lines in FIG. 3, the opening in divider wall 158 is unobstructed, and gas is permitted to flow in parallel through both first portion 154 and second portion 156. While control valve 160 is depicted as a hinged-type valve, it should be understood that any suitable valve configuration may readily be employed by a person skilled in the art. Moreover, it should be understood that valve 160 may be configured for controllable positioning in a plurality of positions intermediate the closed position and the open position.

In operation, under low load conditions (i.e., when the EGR flow rate is low), control valve 160 is in the closed position to inhibit flow through second portion 156 and provide a relatively smaller flow area (i.e., the cross-sectional area of first portion 154). This smaller flow area ensures sufficiently turbulent flow to reduce the amount of soot deposited (i.e., fouling) on first portion 154. Under high load conditions (i.e., when the EGR flow rate is high), control valve 160 is in the opened position to permit flow through second portion 156 in parallel with the flow through first portion 154, thereby providing a relatively larger flow area (i.e., the sum of the cross-sectional areas of first portion 154 and second portion 156). In this manner, the level of turbulence is maintained within an acceptable range to prevent a large pressure drop through cooler package 150.

It should be understood that by facilitating a variable cooler cross-section using control valve 160 in the manner described above, cooler package 150 can be controlled to maintain a Reynolds number in the turbulent flow range under low flow conditions without experiencing the undesirable effects of very high Reynolds numbers under high flow conditions. Moreover, it should be understood that the compact design of a U-shaped cooler package may reduce the space needed to receive the package, and may permit alternate mounting orientations such as vertical instead of horizontal.

While these embodiments have been described as having exemplary designs they may be further modified within the spirit and scope of this disclosure. This application is therefore intended to cover any variations, uses, or adaptations of the disclosed general principles. Further, this application is intended to cover such departures from the present disclosure as come within known or customary practice in the art to which this application pertains.

What is claimed is:

1. A compression ignition engine comprising:
at least one combustion chamber;
an air intake system for conveying air to the at least one combustion chamber;
an exhaust system for conveying exhaust gases from the at least one combustion chamber; and
an exhaust gas recirculation system capable of recirculating a portion of the exhaust gases into the air intake system, the exhaust gas recirculation system comprising a first cooler, a second cooler and a valve;
wherein the valve in an open position allows exhaust gas to flow through the first cooler and the second cooler in parallel and in the closed position inhibits exhaust gas from flowing through the second cooler.

2. The compression ignition engine as set forth in claim 1 wherein the first cooler is liquid cooled.

3. The compression ignition engine as set forth in claim 2 wherein the second cooler is liquid cooled.

4. The compression ignition engine as set forth in claim 1 wherein the first cooler is arranged in a parallel relationship with the second cooler inside a common housing.

5. The compression ignition engine as set forth in claim 4 wherein the first cooler includes an inlet segment, an outlet segment, and a curved segment connecting the inlet segment and the outlet segment, and the second cooler includes an inlet segment, an outlet segment, and a curved segment connecting the inlet segment and the outlet segment.

6. The compression ignition engine as set forth in claim 5 wherein the housing is substantially U-shaped and the inlet segment, outlet segment, and curved segment of the first cooler are disposed in substantially parallel relationship to the inlet segment, outlet segment, and curved segment of the second cooler, respectively.

7. The compression ignition engine as set forth in claim 5 wherein the housing includes an inlet, an outlet, and a divider wall, the valve being disposed adjacent the housing inlet.

8. The compression ignition engine as set forth in claim 7 wherein the divider wall extends from the valve to the housing outlet, thereby separating the first cooler from the second cooler.

9. The compression ignition engine as set forth in claim 1 further including a controller capable of controlling whether the valve is opened or closed.

10. The compression ignition engine as set forth in claim 9 wherein the controller includes a sensor configured to determine the speed of the engine.

11. The compression ignition engine as set forth in claim 1 further including a third exhaust gas recirculation cooler in flow communication with the second cooler.

12. The compression ignition engine as set forth in claim 11 wherein the third exhaust gas recirculation cooler is further connected to the air intake system.

13. The compression ignition engine as set forth in claim 11 wherein the third exhaust gas recirculation cooler is connected in series with the second cooler.

14. The compression ignition engine as set forth in claim 11, wherein the third exhaust gas recirculation cooler is air cooled.

15. The compression ignition engine as set forth in claim 14 wherein the first and second coolers are water cooled.

16. A system for a compression ignition engine, the system comprising:
an intake configured to supply air to the engine;
an exhaust system configured to convey air from the engine; and
an exhaust gas recirculation system for recirculating some of the air to the intake, the exhaust gas recirculation system including a cooler package having a first portion, a second portion and a control valve configured to permit when in a first position parallel flow of air through the first portion and the second portion.

17. The system as set forth in claim 16 wherein the cooler package is a jacket-water cooled unit.

18. The system as set forth in claim 16 further including a second cooler package.

19. The system as set forth in claim 18 wherein the second cooler package is air cooled.

20. The system as set forth in claim 18 wherein the second cooler package is in series with the cooler package.

21. The system as set forth in claim 18 further including a valve between the cooler package and the second cooler package.

22. The system as set forth in claim 16 wherein the first portion, second portion and control valve are disposed in a common U-shaped housing, the first portion being separated from the second portion by a divider wall.

23. The system as set forth in claim 22 wherein the housing includes an inlet, the control valve preventing air flow from the housing inlet to the second portion when in a second position.

24. An exhaust gas recirculation system comprising:
a conduit capable of conducting the passage of a gas;
a first valve having at least a first state that prevents the flow of the gas through the conduit and a second state that allows the gas to flow through the conduit;
a first cooler configured to cool the gas;
a second cooler configured to cool the gas;
a second valve having at least a first state in which the valve directs the gas through the first cooler and a second state in which the valve permits a parallel flow of the gas through the first cooler and the second cooler.

25. The exhaust gas recirculation system as set forth in claim 24 wherein the first cooler, the second cooler and the second valve are mounted within a common housing.

26. The exhaust gas recirculation system as set forth in claim 24 wherein the common housing is substantially U-shaped with an inlet at one end and an outlet at another end, the first and second coolers extending from the inlet to the outlet in substantially parallel relationship to one another.

27. The exhaust gas recirculation system as set forth in claim 26 wherein the second valve is disposed adjacent the housing inlet, the second valve when in the first state cooperating with a divider wall disposed in the housing between the first cooler and the second cooler to prevent gas flow through the second cooler.

28. The exhaust gas recirculation system as set forth in claim 24 further including an intercooler, wherein the first valve further controls the flow of the gas through the intercooler.

29. The exhaust gas recirculation system as set forth in claim 24 wherein the gas first passes through the first cooler prior to the first valve.

30. A method of operating a cooling system configured to cool a fluid comprising the steps of:
flowing at least a first portion of the fluid through a first cooler; and
utilizing a valve to control whether a second portion of the fluid flows through a second cooler;
wherein no portion of the fluid flows through both the first cooler and the second cooler.

31. The method of operating a cooling system as set forth in claim 30 wherein the first cooler, the second cooler and the valve form a unitary apparatus.

32. The method of operating a cooling system as set forth in claim 31 wherein the unitary apparatus is substantially U-shaped having an inlet and an outlet, the first and second coolers extending in substantially parallel relationship to one another from the inlet to the outlet.

33. The method of operating a cooling system as set forth in claim 30 further including the step of utilizing a second valve to control the flow of the fluid through a third cooler.

34. The method of operating a cooling system as set forth in claim 33 wherein at least a portion of the fluid passing through the third cooler has passed through the first cooler.
